(19) United States
(12) Patent Application Publication
(10) Pub. No.: US 2015/0336653 A1
(43) Pub. Date: Nov. 26, 2015

(54) Air Pumping Device

(71) Applicants: Robert B. Anderson, Camarillo, CA (US); Gregory S. Graham, Camarillo, CA (US)

(72) Inventors: Robert B. Anderson, Camarillo, CA (US); Gregory S. Graham, Camarillo, CA (US)

(21) Appl. No.: 14/717,732

(22) Filed: May 20, 2015

Related U.S. Application Data
(63) Continuation of application No. 62/002,856, filed on May 25, 2014.

(51) Int. Cl. B64B 1/62; F04D 29/053; F04D 29/32; F04D 19/00; F04D 25/06

(52) U.S. Cl. CPC B64B 1/62; F04D 19/002; F04D 25/06; F04D 29/32; F04D 29/053

(57) ABSTRACT

An air pumping device for the buoyancy control of a lighter than air craft is presented. The pumping device integrates within a single housing a centrifugal compressor and an axial gap, ironless core, electric motor. All of the rotating components of the compressor and motor are mounted on a single common shaft. The air pumping device includes a valve arrangement which allows for both forward and reverse airflow though the compressor portion of the device. The motor portion of the device features a stator coil and power, communications and sensor electronics, all integrated on a single common printed circuit board. The air pumping device exhibits exceptionally high operating efficiency and power density, which are highly desirable for lighter than air craft applications.

### CROSS REFERENCE TO RELATED APPLICATION

This application claims the benefit of U.S. provisional patent application No. 62/002,856 filed on May 25, 2014, the entirety of which is hereby incorporated by reference.

### FIELD OF THE INVENTION

The present invention relates generally to devices for providing active control of the aerostatic lift of an aerostat or balloon and, more particularly, to a device for actively controlling the static lift of an aerostat or balloon by altering the ratio of air to lifting gas contained within the aerostat or balloon via pneumatic means. The present invention relates generally as well to forced air devices such as heating and cooling systems that require forced air.

### BACKGROUND OF THE INVENTION

Balloons and aerostats employ a lifting gas, such as helium, to fill an envelope and create static lift. Early balloons and aerostats were single envelope designs, i.e. designs which featured a single envelope for the lifting gas. These craft had no ability to control the amount of static lift and hence had no ability to control their rate of ascent or to descend, other than by means of carrying ballast which could be jettisoned during flight to increase lift and by venting lifting gas to the atmosphere to decrease lift.

Additionally forced air is used to pump ambient air through radiators to add or remove heat from a source such as heating and air conditioning devices. These devices often have non-linear flow across their surfaces reducing the overall efficiency of the system. Radiator systems typically have fans central to the square configuration of the cooling fins. This leaves the corners with much lower and turbulent air flow resulting in lower overall heat removal capacity. Efficient and linear forced air for use in heating, cooling and industrial systems improves total energy consumption. In the event that uniform airflow is required across the face area of a large heat exchanger, for example, a plurality of fans may be arranged into an array, with each having either separate and individual control, such as variable speed, on/off, etc., or they may alternatively be controlled as a group. If fans in such an array are used to pressurize a plenum, and individual control means is also desired, then the individual fans must also include means of providing unidirectional flow, known otherwise as backflow prevention in the art.

These early methods of altitude control quickly proved to be problematic. The carrying of ballast to increase lift through subsequent jettisoning reduces initial payload capacity, and once jettisoned the ballast, generally, cannot be recovered. The release of lifting gas to the atmosphere to reduce lift is likewise disadvantageous because, once released, the lifting gas cannot be recovered and subsequent increases in altitude are no longer possible without the further jettisoning of ballast. Moreover, the only commercially available non-flammable lifting gas, helium, is a relatively expensive commodity which further makes atmospheric venting unattractive.

Subsequent balloon and aerostat designs adopted the use of duel envelopes, i.e. envelope within an envelope designs to provide for buoyancy control. In dual envelope balloon and aerostat configurations, an outer envelope is inflated with a lifting gas, typically helium, while an inner envelope or ballonet, is inflated with a higher density gas, typically air, to provide ballast. In a dual envelope design, buoyancy control is accomplished by increasing or decreasing the volume of the inner envelope which increases or decreases the mass of the inner envelope. Decreasing the volume of air in the inner envelope reduces the mass of heavier gas and thus increases static lift. Conversely, increasing the volume of air in the inner envelope increases the mass of heavier air and thus decreases static lift for the combined envelope. The advantage of a dual envelope design is that bi-directional altitude control of the balloon or aersostat may be achieved without the need to either carry and jettison ballast or vent lifting gas to the atmosphere.

Through use of smart controls, dual envelope craft are able to repeatedly gain or reduce altitude, or loiter at a fixed altitude, at will. Such altitude control is highly desired in station-keeping missions where solar heating causes significant day/night temperature differentials which in turn create substantial altitude variations. Similar conditions may arise when, for example, navigation is dependent upon the prevailing patterns of high altitude winds, and where altitude control must be used in order to position the craft within the desired wind pattern at the appropriate time.

Prior art ballonet or inner envelope inflation systems, typically utilizing stored compressed gasses, and/or compression systems and relatively complex valve arrangements, have been proposed. All such systems are believed to have drawbacks with the principle drawback being excess weight, which reduces payload capacity. The art of ballonet inflation systems is presently undergoing change in response to new design concepts for lighter than air craft. At the present time, no particular inflation system has proven to be superior and the industry has yet to settle on a standardized design. Thus, there remains room for improvement in the art.

It is desirable for a ballonet inflation system for use on a lighter than air craft to be as compact, efficient, and lightweight as possible. This is due to the fact that such equipment consumes a portion of the available payload in a parasitic manner. Further, such equipment may rely upon photovoltaic power generation and battery energy storage. Inefficient equipment requires that power generation and storage equipment be upwardly scaled to account for such inefficiencies which adds yet more parasitic weight.

It is an object of the present invention to present an improved air pumping device for buoyancy control of lighter than air craft.

It is another object of the present invention to minimize the weight and packaging volume of such an improved buoyancy control system.

It is a further object of the present invention to maximize the operating efficiency and hence minimize the power consumption of such an improved buoyancy control system.

It is a further object of the invention to present an improved air pumping device for use in residential and commercial heating and cooling systems and other industrial systems which require forced air flow or a controllable source of high volume, pressurized air.

### SUMMARY OF THE INVENTION

The air pumping device of the present invention solves many of the problems associated with prior art lighter than air craft buoyancy control systems by providing a high volume compressor and a particularly efficient electric motor design, integrated within a single housing, wherein all rotating components of the compressor and motor are mounted on a single common rotating shaft. The compressor portion of the air pumping device includes a compression chamber featuring a plurality of one-way flow control or check valves, as well as a plurality of selectively controllable, electrically actuated, two-way flow control valves, where the two-way flow control valves allow for the backflow of air through the housing—a desirable characteristic in buoyancy control applications.

The electric motor portion of the device is a direct current (“DC”) motor design featuring two magnetic rotors with a stator assembly disposed there between. The rotors include magnetic faces formed from a permanent magnet material which are spaced equidistant from the stator assembly, thereby defining an air gap between the rotor faces and the stator assembly. The stator assembly is a printed circuit board which includes an “ironless” stator coil, as well as all power, communications and sensor electronics needed to operate the motor, all of which are integrated on the single, common printed circuit board. The air pumping device of the present invention, exhibits exceptionally high operating efficiency and power density, which are highly desirable in lighter than air craft applications.

This same invention with changes to the flow control valves can be utilized in forced air systems where the flow control is limited to a single direction and the flow control valves are used to prevent the reverse movement of air i.e. one-way or check valves.

The above and other features of the invention will become more apparent from the following detailed description.

### BRIEF DESCRIPTION OF THE DRAWINGS

FIG. 1 is a cross-sectional view of a first embodiment of an air pumping device in accordance with the present invention.

FIG. 2 is perspective view of the aft or discharge side of the air pumping device of FIG. 1.

FIG. 3 is an exploded view of the air pumping device FIG. 1.

FIG. 4A is a perspective view of a magnetic rotor assembly of the motor of the air pumping device of FIG. 1, showing the iron side of the rotor assembly.

FIG. 4B is a perspective view of a magnetic rotor assembly of the motor of the air pumping device of FIG. 1, showing the magnet side of the rotor assembly.

FIG. 5A is a front facing perspective view of an axial gap DC electric motor in accordance with the principles of the present invention, suitable for use in the air pumping device of FIG. 1.

FIG. 5B is a rear facing perspective view of the axial gap DC electric motor of FIG. 5A, suitable for use in the air pumping device of FIG. 1.

FIG. 6 is a sectional view of the axial gap DC electric motor of FIG. 5A.

FIG. 7 is a schematic view showing the air pumping device of FIG. 1, as installed in a dual envelope, high altitude balloon application.

FIG. 8 is a sectional view of a second embodiment of an air pumping device in accordance with the present invention.

FIG. 9 is perspective view of the aft or discharge side of the embodiment of the air pumping device of FIG. 8.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

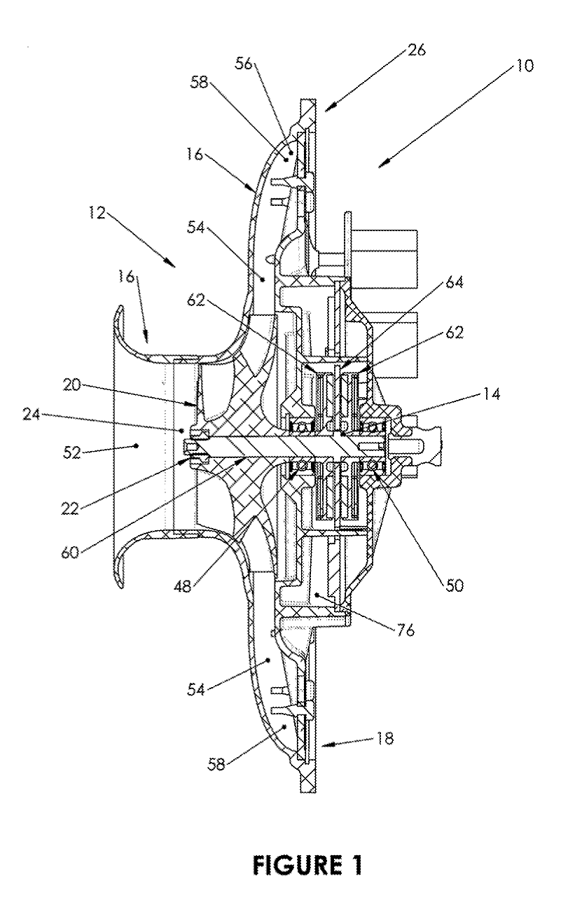

With reference to FIGS. 1-3, a first embodiment 10 of an air pumping device suitable for the buoyancy control of lighter-than-air craft is shown. The first embodiment 10 of the air pumping device features a centrifugal compressor assembly 12 and an axial gap motor 14 of axial gap, DC design, wherein both the centrifugal compressor assembly 12 and the axial gap motor 14 utilize a common shaft 60. The first embodiment 10 of the air pumping device is fully integrated and contains all necessary operative components within a single housing assembly 17. The housing assembly 17 comprises a housing 18, a shroud 16, and a housing cover 74.

The centrifugal compressor assembly 12 includes the shroud 16, the housing 18 having an air compression side 56 and an air discharge side 26, the housing cover 74 and an impeller 20. The housing 18 and housing cover 74 support the common shaft 60 via anti-friction radial ball bearing assemblies 48 and 50 mounted in the housing 18 and housing cover 74, respectively. Mounted on the common shaft 60 is the impeller 20, which is secured to the common shaft 60 via a nut 22 and a threaded portion 24 of the common shaft 60. Mounted to the housing 18 and enclosing the impeller 22 is the shroud 16 which features an air inlet 52. Formed between the shroud 16 and a compression side 56 of the housing 18 is an air compression chamber 54, which includes an upper portion 58.

Incorporated into the housing 18 are a plurality of openings 28 into which are mounted one-way flow control or check valves 30A through 30K. Mounted to the air discharge side 26 of the housing 18 are valve assemblies 32 and 34. Each of the valve assemblies 32 and 34 include a plurality of electrically operated linear actuators 36A through 36C and 38A through 38C. The linear actuators 36A through 36C operate corresponding valves 40A through 40C which control airflow through certain of the plurality of openings 28 in the housing 18. Similarly, the linear actuators 38A through 38C actuate a plurality of valves 42A through 42C which likewise control airflow through certain of the plurality of openings 28. The flow control valves 30A through 30K, 40A through 40C, and 42A through 42C, are in fluid communication with the compression chamber 54 and an ambient environment external to the compression chamber.

With reference to FIGS. 1 and 3-6, the axial gap motor 14 is enclosed within a singular cavity 76 within the housing 18. The cavity 76 is closed-out by the housing cover 74. (See FIG. 1.) The axial gap motor 14 includes a pair of magnetic rotor assemblies 62 and a stator assembly 68, in the form of a printed circuit board (“PCB”), which is disposed between the magnetic rotor assemblies 62. The stator assembly 68 of the axial gap motor 14 includes all power electronic components, logic interface, modules, sensors and circuitry required to operate the axial gap motor 14, as well as valve assemblies 32 and 34.

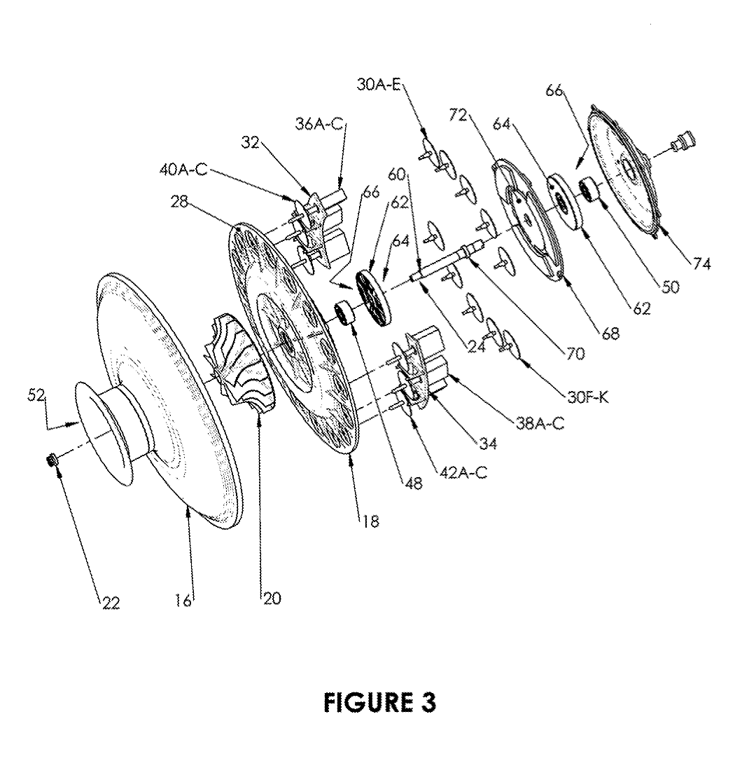

The magnetic rotor assemblies 62 and stator assembly 68 are each mounted on the common shaft 60. Each of the pair of magnetic rotor assemblies 62 has a magnetic side 64 having a magnetic face 78, and an iron side 66. The magnetic rotor assemblies 62 are mounted on the common shaft 60, such that each of the magnetic faces 78 bear against a shoulder 70 of the common shaft 60. (See FIG. 3.) The stator assembly 68 is positioned on the shoulder 70 of the common shaft 60, centrally between the magnetic faces 70 of the magnetic rotor assemblies 62, with the magnetic rotor faces 70 each being axially spaced and equidistant from stator bearing faces 72, and defining an air gap or axial gap 71. (See FIGS. 3 and 6.)

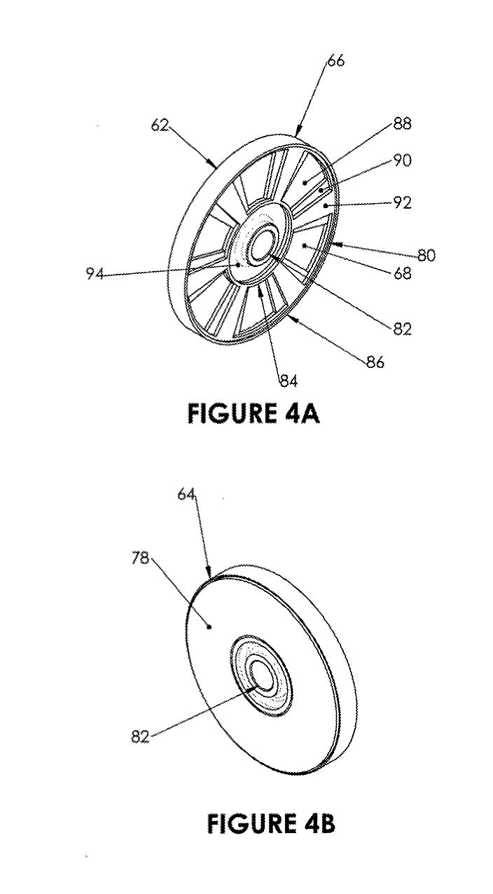

Referring now to FIGS. 4A and 4B, the magnetic rotor assembly 62 of the axial gap motor 14 is shown in more detail. The magnetic rotor assembly 62 includes a core 80 composed of a generally ferrous based material. The core 80 comprises a center hub 82, an intermediate reinforcing ring 84 and outer rim 86. Disposed between the hub 82 and the intermediate reinforcing ring 84 is an inner web region 94. Disposed between the intermediate reinforcing ring 84 and the outer rim 86 is an outer web region 88. (See FIG. 4A.) The magnet side 64 of the rotor assembly 62 includes the magnetic face 78. The magnetic face 78 is a thin, disk-like form of rare earth, high permeability, permanent magnetic material, such as Neodymium, which is bonded to the core 80.

The iron side 66 of the magnetic rotor assembly 62 is populated with a plurality of thin laminar layers 90 and 92 of ferrous material, formed in the outer web region 88. This laminar construction more optimally shapes the amount and location of the ferrous material in order to provide an efficient magnetic circuit function for the axial gap motor 14, while eliminating ferrous material where it is of little to no use. The laminar layers 90 and 92 are arranged so that the thickest portion of the stacked layers lies directly behind a line at which the permanent magnet (i.e. magnetic face 78) changes pole direction, i.e., from north to south. The point at where the magnet poles reverse being also the point at where magnetic flux in the back iron (i.e. layers 90 and 92) is maximum, and therefore the location at where the maximum amount of back iron is required.

The laminar layers 90 and 92 are bonded to the outer web region 88 of the core 80. Each laminar layer 90 and 92, may consist of one or more layers with a greater number of thinner material layers inuring to a more optimal shape. The layers 90 and 92 are preferably formed using stamped or die cutting processes of low cost sheet material, making for an easily manufacturable, low cost construction.

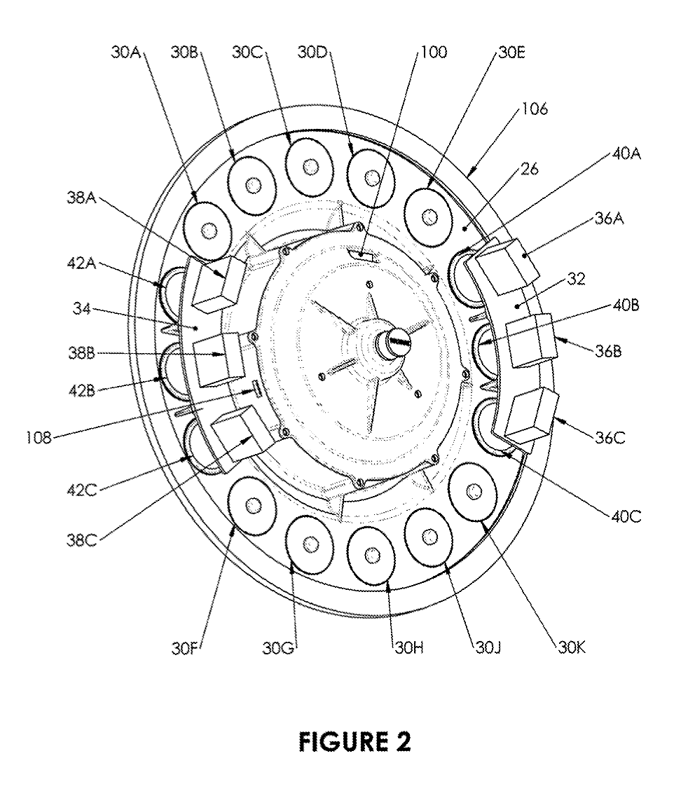

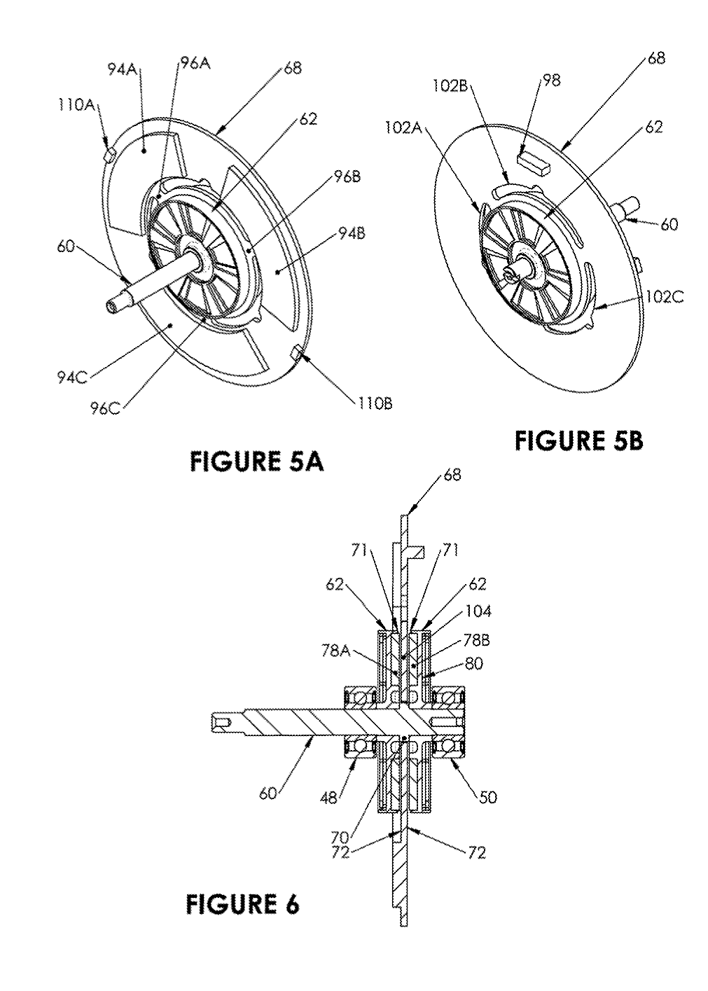

Referring now to FIGS. 5A and 5B the front and back sides, respectively, of the axial gap motor 14 are depicted. The stator assembly 68 is now clearly seen. An interior portion of the stator assembly (not shown) is populated with circuit traces that form the stator coil for the axial gap motor 14. In other embodiments, this coil aspect may be built onto the board using wire, or Litz wire, or other methods. Electronics modules which include power, communications and sensor electronics, are necessary to operate the axial gap motor at high speeds, and these are shown at 94A, 94B, and 94C. These electronics modules 94A, 94B and 94C are shown corresponding to a wye-connected, 3-phase AC motor. The electronics modules 94A through 94C also control the valve assemblies 32 and 34. Electrical connections (not shown) for the valve assemblies 32 and 34 penetrate the housing at slots 108A (see FIG. 2) and 108B. (Slot 108B, not shown is 180 degrees opposite of slot 108A.) and connect directly to the electronics modules 94A through 94C at connectors 110A and 110B.

In lieu of connecting wires, drive power for the axial gap motor is conducted via PCB traces at 96A, 96B, and 96C. DC power and all low-level logic control and communication for the air pumping device 10 are secured at electrical connector 98. Connector 98 is accessible from the aft end of the first embodiment 10 of the air pumping device via slot 100 (see FIG. 2). Three semicircular slots 102A, 102B and 102C are installed in the stator assembly 68, as depicted in FIG. 5B. The slots 102A-102C interface with metallic walls (not shown) of the housing 18 which penetrate the stator assembly 68 for the purpose of providing electro-magnetic shielding between the axial gap motor 14 and the power electronics modules 94A, 94B and 94C of the stator assembly 68.

Referring now to FIG. 6, a cross sectional view of the axial gap motor 14 is shown. The rotor assemblies 62 are positioned concentrically with each secured to the common shaft 60 via an interference fit and precisely positioned axially at the shoulder 70. This establishes an air gap relationship between the magnetic faces 78 of the magnetic rotor assemblies 62, and an electromagnet portion 104 of the stator assembly 68. Preferably, the axial air gap is as small as possible to maximize the magnetic gap field strength and reduce or minimize the material in the rotor components 62. This results in improved efficiency and power density performance of the axial gap motor 14.

### Operation of the Air Pumping Device of the Present Invention

With reference to FIGS. 1-3, ambient air is drawn from the atmosphere at the air inlet 52 of the shroud 16 and is compressed by the impeller 20, which is mounted to the common shaft 60 and secured thereto by the nut 22. The common shaft 60 is supported by the antifriction radial ball bearing assemblies 48 and 50 which allow for high speed rotary operation of the impeller 20. Mounted to common shaft 60 are the pair of magnetic rotor assemblies 62 which are responsible for applying motive torque to the common shaft 60 and thereby operate the impeller 20. Directly between the magnetic faces 78 of the magnetic rotor assemblies 62 is the stator assembly 68, which comprises a thin, multi-layered PCB. In the exemplary embodiment, the PCB is absent of any iron or ferrous material. The axial gap motor 14, therefore, is of the ironless core type and exhibits extremely low inductance.

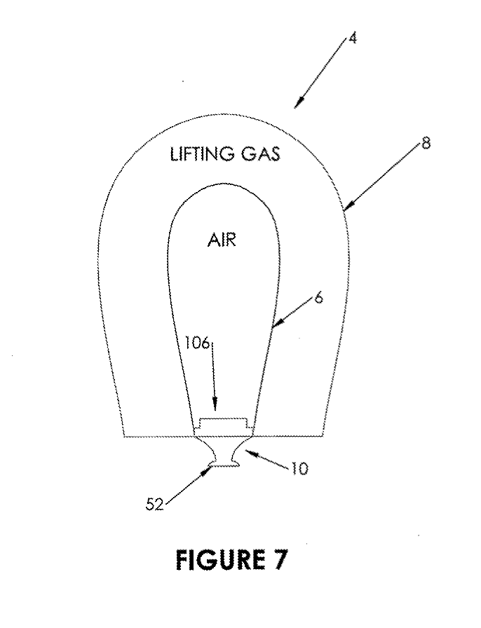

Referring now to FIG. 7, in a typical installation, the first embodiment 10 of the air pumping device of the present invention will be used with a lighter-than-air craft, such as a high altitude balloon 4, having a lifting gas envelope 8 and an internal ballast envelope or ballonet 6. In such installations, the air discharge side 106 of the first embodiment 10 of the air pumping device will be connected in fluid communication with the ballast envelope 6 of the balloon 4. Thus, air pumped by the air pumping device 10 may inflate the ballast envelope 6.

With, reference to FIGS. 1-3 and 7, the impeller 20 discharges pressurized air into the compression chamber 54 making available air at a pressure differential of, for example, 25% above the ambient at the upper portion 58 of the compression cavity 54 and to the underside of the plurality one-way check valves 30A through 30K. (See FIG. 2.) In the exemplary embodiment, the one-way check valves 30A through 30K are “flapper” style valves constructed of a thin elastomeric material, such as silicone rubber or vinyl and exhibit very low pressure force needed to open in a forward flow direction. At high altitudes where the ambient barometric pressure is at, for example, 1.30 in-Hg (mercury), a 25% pressure increase results in only 4.4 in-Wc (water column) pressure differential across the check valves 30A through 30K, and this pressure must be held leak-tight within the ballast envelope 6. The check valves 30A through 30K perform this function.

Bi-directional flow control through the first embodiment 10 of the air pumping device is necessary if the high altitude balloon is intended to have the ability to both increase and decrease in altitude at will. Increasing the volume of the ballast envelope 6 causes a corresponding increase in the total system mass which thereby causes the balloon 4 to lose static lift and decrease in altitude. Decreasing the volume of the ballast envelope 6 on the other hand, reduces the total system mass which therefore increases static lift and allows the balloon 4 to gain altitude. (A dual envelope balloon may increase in altitude up to its pressure height, i.e. the point at which the volume of the ballast envelope is zero.) Therefore, in order to achieve bi-directional altitude control, the ballast envelope 6 must be controllably inflated with pressurized air, and exhausted, as needed.

In the first embodiment 10 of the air pumping device of the present invention, exhaustion of pressurized air from the ballast envelope 6 is accomplished by allowing the air to back flow through the first embodiment 10 of the air pumping device. Valve assemblies 32 and 34 provide this function. Valve assembly 34 is replicated by assembly 32, so description is limited to this one case. In the exemplary embodiment, the linear actuators 36A through 36C are of the self-locking type, i.e. power is only required to move the actuator to a new position, and no power is required to hold at any given position. The valves 42A through 42C are attached to actuator rods of the linear actuators 38A through 38C, and are shown in the closed position. This position is desired when pumping up the ballast envelope 6 to reduce altitude. Conversely, when altitude gain is desired, actuators 36A through 36C, and 38A through 38C are energized, opening valves 40A through 40C and 42A through 42C. The impeller 20 (see FIG. 1) is now at rest and pressurized ballast air may now escape by back-flowing into the compression chamber 54 and discharging back to the atmosphere at air inlet 52 of the first embodiment 10 of the air pumping device.

It should be additionally noted that the actuated valve assemblies 32 and 34 may also be operated when the air pump is active and filling the ballast envelope 6, and thereby increase the overall air flow passage area by 60%. For example, more rapid inflation of the ballast envelope 6 may be desired in some situations and the valve assemblies may therefore be activated to allow for increased air flow rate.

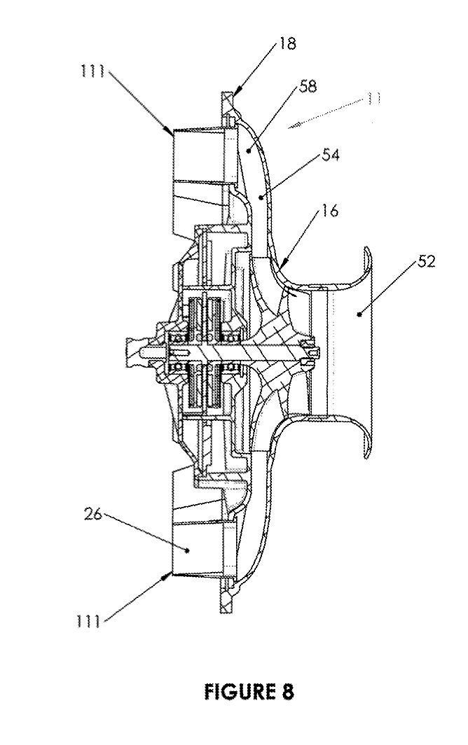

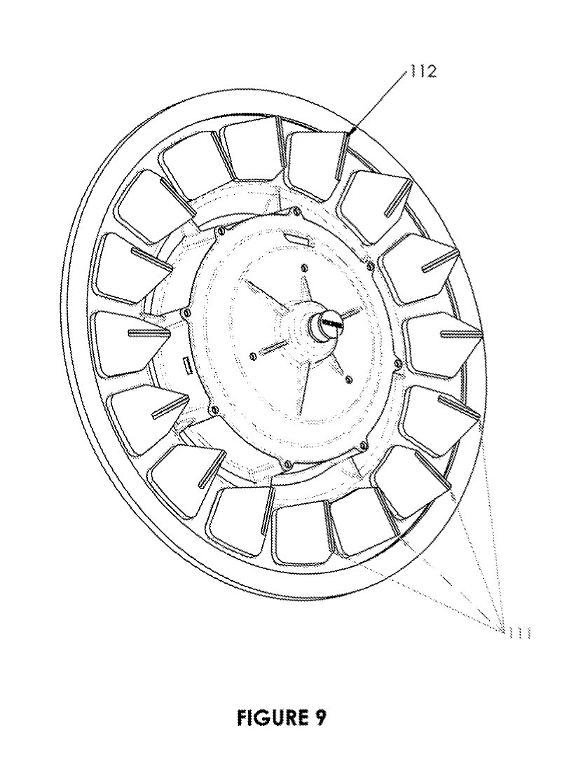

With reference to FIGS. 8-9, a second embodiment 11 of the air pumping device of the present invention is shown. The second embodiment 11 of the air pumping device may provide functional advantages in heat exchanger and like applications. The second embodiment 11 of the air pumping device is generally similar to the previously described first embodiment 10 of the air pumping device in all material respects, except as noted below. The second embodiment 11 principally differs from the first embodiment 10 in that in the second embodiment 11, the two-way valves 40A through 40C and 42A through 42C, as well as the one-way check valves 30A through 30K (see FIG. 2) are replaced with a plurality of one-way flow control or check valves 111. The plurality of flow control valves 111, are in fluid communication with the compression chamber 54 and an ambient environment external to the compression chamber 54.

In the exemplary second embodiment 11 of the air pumping device, the one-way check valves 111 are duckbill style check valves. Duckbill style check valves are elastomeric check valves that allow forward air flow in response to a positive differential pressure. Conversely, in response to a negative pressure differential, reverse airflow or backflow is prevented or checked. Duckbill check valves are commercially available and can be designed to open over a wide range of positive pressures depending on valve size, geometry, and elastomeric compound characteristics.

The plurality of one-way check valves 111 are inserted in the plurality of openings 28 in the housing 18. (See FIG. 3.) The one-way check valves 111 serve to prevent reverse air flow or backflow into the compression chamber 54 in response to negative pressure differentials while allowing for forward flow in response to positive pressure differentials. Air entering the air inlet 52 through the shroud 16, enters the compression side 56 of the housing 18 via the air compression chamber 54, which includes an upper portion 58. Air pressure opens the plurality of one-way check valves 111 allowing air flow from the compression chamber 54 through to the discharge side 26 of the housing.

With reference to FIG. 9, the one-way check valves 111 are radially spaced about the housing 18 and form an axial discharge ring about the housing 18. The one-way check valves 111 are equipped with slot-like discharge orifices 112 which perform considerable straightening of the discharge airflow resulting in a more uniform velocity gradient, and hence uniformity of airflow presented to downstream devices, such as heat exchangers.

### Advantages of the Air Pumping Device of the Present Invention

The Impeller 20 must be operated at relatively high speed and, in the exemplary embodiment, shaft speeds of 30,000 RPM or greater are both possible and required. Shaft speeds of 30,000 RPM or greater are necessary to produce a discharge pressure of the air pumping device 10 in a desired range of about 15%-35% above the ambient air pressure at the air inlet 52, or a pressure ratio of 1.15-1.35. The axial gap motor 14 is directly mounted to the common shaft 60 as is the impeller 20, and therefore must operate at the same rotary speed. In traditional permanent magnet motor designs, high speed operation results in significant loss in the stator iron structure. These are termed “iron losses” and become dominant at the speeds of interest. Therefore, an iron-less core construction will eliminate these dominant high speed losses, as no ferrous material exists in the stator structure, and the axial gap motor can attain high speed operation at extremely high efficiency, with minimal thermal load. Such efficiency is highly desired for lighter than air craft as operating power during extended deployments is often reliant upon photovoltaic solar cells and batteries. Maximizing the operating efficiency of the buoyancy control air pump device therefore will minimize the photovoltaic and battery capacity needed, and associated parasitic payload.

Another advantage of the iron-less core axial gap motor 14 is extreme power density. Ironless core axial gap motors of greater than 8 kW/kg have been demonstrated in the literature, and this level of power density is far greater than that attainable by traditional, slotted coil construction designs. Such performance is extremely important for lighter than air craft applications to further reduce the parasitic payload component. Further reducing mass is the integration of the power, communications and sensor electronics (94A through 94C) onto the PCB of the stator assembly 68 (FIG. 3), which eliminates the need for additional sub-assemblies external to the air pumping device. This will also reduce the number of connections required for operation. The air pumping device of the present invention 10 requires only 2-wire DC power and communications connections, which are further included onto a single connector (shown at 100 in FIGS. 2 and 98 in FIG. 5B). A non-limiting example would be to communicate with the air pumping device bi-directionally via a CAN bus, or similar architecture, with CAN requiring only two additional wires. Additional savings would be to communicate with wireless connection.

Another advantage which may be of particular value in heat exchanger applications regards the ability to tailor the discharge air flow characteristics of the air pumping device. Depending upon the needs of any particular application, flow control valves may be selected that control both the volume of air flow and the characteristics of the discharge air. For example, in heat exchanges applications, the ability to uniformly distribute large volumes of air over the face of a radiator would likely prove advantageous. This uniformity of air distribution provides for higher utilization of the radiator surface area extracting a maximum heat over the entire surface.

The above described advantages result in an air pumping device exhibiting exceptional operating efficiency and power density. The exemplary embodiment described herein for example, results in a 300-watt class machine a total mass of approximately 1700 grams (3.75 pounds).

What is claimed is:

1. An air pumping device, comprising:
a compressor, including an impeller and a compression chamber;
a motor, including two rotors and a stator;
wherein the impeller and the rotors are mounted on a common rotatable shaft; and
wherein the stator is disposed between the rotors, such that each rotor is equidistant from the stator to define an air gap between each rotor and the stator.

2. The air pumping device of claim 1, wherein the motor further includes an electronics module, the electronics module including all power, communications and sensor electronics required to operate the motor, wherein the electronics module is integrated onto the stator.

3. The air pumping device of claim 2, wherein the motor further includes a stator coil, wherein the stator coil and electronics module are substantially constructed onto a single common printed circuit board.

4. The air pumping device of claim 3, wherein the stator is of ironless construction.

5. The air pumping device of claim 1, wherein the rotors are of permanent magnet construction.

6. The air pumping device of claim 1, wherein the compressor includes a plurality of one-way flow control valves, wherein the one-way flow coin valves allow air to be released from the compression chamber at predetermined pressure levels.

7. The air pumping device of claim 1, wherein the compressor includes a plurality of two-way flow control valves, wherein the two-way flow control valves are selectively controllable to allow air to either exit or enter the compression chamber.

8. The air pumping device of claim 8, wherein the plurality of two-way flow control valves is operated at least one electrically operated actuator.

9. The air pumping device of claim 8, wherein the at least one electrically operated actuator is controlled by the electronics module.

10. An air pumping device, comprising:
a compressor, including an impeller and a compression chamber;
a motor, including at least two rotors and a stator, the stator disposed between the rotors such that each rotor is equidistant from the stator;
wherein the impeller and the at least two rotors are mounted on a common rotatable shaft; and
wherein the compressor includes a plurality of one-way flow control valves, wherein the plurality of one-way flow control valves allow air to be released from the compression chamber at predetermined pressure levels.

11. The air pumping device of claim 10, wherein the motor further includes an electronics module, the electronics module including all power, communications and sensor electronics required to operate the motor, wherein the electronics module is integrated onto the stator.

12. The air pumping device of claim 11, wherein the motor further includes a stator coil, wherein the stator coil and electronics module are substantially constructed onto a single common printed circuit board.

13. The air pumping device of claim 12, wherein the stator is of ironless construction.

14. The air pumping device of claim 10, wherein the compressor includes a plurality of two-way flow control valves, wherein the two-way flow control valves are selectively controllable to allow air to either exit or enter the compression chamber.

15. The air pumping device of claim 14, wherein the plurality of two-way flow control valves is operated by at least one electrically operated actuator.

16. The air pumping device of claim 15, wherein the at least one electrically operated actuator is controlled by the electronics module.

17. An air pumping device, comprising:
a compressor, including an impeller and a compression chamber;
a motor, including at least two rotors and a stator, the stator disposed between the rotors such that each rotor is equidistant from the stator;
wherein the impeller and the at least two rotors are mounted on a common rotatable shaft; and
wherein the compressor includes a plurality of one-way flow control valves, wherein the one-way flow control valves allow air to be released from the compression chamber at predetermined pressure levels;
wherein the compressor includes a plurality of two-way flow control valves, wherein the two-way flow control valves are selectively controllable to allow air to either exit or enter the compression chamber.

18. The air pumping device of claim 17, wherein the motor further includes an electronics module, the electronics module including all power, communications and sensor electronics required to operate the motor, wherein the electronics module is integrated onto the stator.

19. The air pumping device of claim 18, wherein the motor further includes a stator coil, wherein the stator coil and electronics module are substantially constructed onto a single common printed circuit board.

20. The air pumping device of claim 14, wherein the plurality of two-way flow control valves is operated by at least one electrically operated actuator, the at least one electrically operated actuator being controlled by the electronics module.

21. The air pumping device of claim 1, wherein the compressor includes a plurality of flow control valves, responsive to air pressure, the flow control valves being in fluid communication with the compression chamber and an ambient environment external to the compression chamber, wherein the flow control valves open to discharge air from the compression chamber when air pressure within the chamber exceeds ambient air pressure by a predetermined amount, and wherein the flow control valves close to prevent the reverse flow of air into the compression chamber when ambient air pressure exceeds compression chamber air pressure.

22. The air pumping device of claim 21, wherein the flow control valves are duckbill style, one-way check valves.

23. The air pumping device of claim 10, wherein the plurality of one-way flow control valves prevent the backflow of air into the compression chamber.

24. The air pumping device of claim 23, wherein the flow control valves are duckbill style, one-way check valves.
